(19) United States
(12) Patent Application Publication
(10) Pub. No.: US 2007/0100878 A1
(43) Pub. Date: May 3, 2007

(54) Group sorted consolidation of data in an intrusion management system

(75) Inventors: Robert Fielding, Lorton, VA (US); Eric Dale, Pasadena, MD (US)

Correspondence Address: BLANK ROME LLP, 600 NEW HAMPSHIRE AVENUE, N.W., WASHINGTON, DC, 20037, US

(73) Assignee: NFR Security, Inc.

(21) Appl. No.: 11/586,689

(22) Filed: Oct. 26, 2006

Related U.S. Application Data
(60) Provisional application No. 60/731,986, filed on Oct. 28, 2005.

(51) Int. Cl. G06F 7/00

(52) U.S. Cl. 707/102

(57) ABSTRACT

A method for dynamically representing events detected by an intrusion management system in a communication with a monitored computer system is disclosed. The method includes the steps of receiving data representing detected events in real time, displaying the data in a browser window of the intrusion management system, aggregating, automatically, data in the browser window to highlight patterns therein, without the intervention of a user of the intrusion management system and updating the aggregated data based on newly received data and selections by the user of the intrusion management system.

### REFERENCE TO RELATED APPLICATION

The present application claims the benefit of U.S. Provisional Patent Application No. 60/731,986, filed Oct. 28, 2005, whose disclosure is hereby incorporated by reference in its entirety into the present disclosure.

### FIELD OF THE INVENTION

The present invention is directed to an intrusion management system for detecting attacks against a computer system or network and more particularly to such a system in which the display is modified to better allow for identification and characterization of alerts.

### DESCRIPTION OF RELATED ART

The job of an Intrusion Management System is to detect attacks against computer systems or computer networks. Once an attack is detected, the Intrusion Management System is responsible for presenting forensic information about the attack to a human examiner. Furthermore, the Intrusion Management System (abbreviated to “IMS” from here forward) can also be responsible for preventing attacks from succeeding.

Traditionally, as shown in FIG. 1, communication between the Internet 102 and a monitored network 106 is monitored through an IMS 104. From the standpoint of computer security, the diagram appears as shown in FIG. 1, in which an attacker 108 mounts an attack against the monitored network 106 through the Internet 102 and the IMS 104. The elements of the IMS 104 can include, as illustrated in FIG. 2, a sensor 201, a server 202 and a protection center 203. The protection center 203 allows for control and monitoring of the system through software discussed below.

Most Intrusion Detection and Prevention Systems have some sort of alert browser. An alert browser is a table of events representing things that have happened on the network. Some industry observers think of Intrusion Detection and Prevention systems as hard to use in general because of the volume of alert events that an analyst could be faced with. While some systems allow for changes to be made in the configurations of the browser window, such changes must be made on a case-by-case basis. Most alert browsers will allow the user to re-arrange columns, sort by a column, and to filter out alerts from the browser. But most of them have trouble making a very large and quickly changing list of data comprehensible at a glance. Such changes, however, allow for events to be passed to the analyst where they still must be dealt with. Requiring an analyst to potentially cope with millions of new events being received per day causes fatigue and can increase an overall error rate.

Thus, there is a need in the prior art to have systems that allow for analysts to better handle the volume of data through innovative presentation of the data, and through tuning out events that an analyst should not be bothered with.

### SUMMARY OF THE INVENTION

It is thus an object of the present invention to provide a system that allows alert data to be presented to an analyst in innovative ways that allow for the discovery and highlighting of patterns in the data.

To achieve the above and other objects, the present invention is directed to a method for dynamically representing events detected by an intrusion management system in a communication with a monitored computer system. The method includes the steps of receiving data representing detected events in real time, displaying the data in a browser window of the intrusion management system, aggregating, automatically, data in the browser window to highlight patterns therein, without intervention of a user of the intrusion management system and updating the aggregated data based on newly received data and selections by the user of the intrusion management system.

Preferably, the steps of displaying and aggregating include displaying large amounts of tabular data and sorting from left to right on all the tabular data such that the sorting clusters the tabular data together into a tree structure with a hierarchy. The hierarchy can be modified in real-time to provide patterns in the data. Entries in the tabular data may be colored to provide at a glance illustration of the hierarchy of the tabular data, where the coloring of the entries of the tabular data may be modified in real-time to provide patterns in the data. The entries may also be grouped into clusters based on the coloring of the entries of the tabular data. The method may also include displaying pie chart distributions of the tabular data that is being aggregated.

Also, the step of displaying may include displaying time based occurrences with a pie chart for each time interval to show a distribution of a primary attribute for the detected events. The primary attribute may be a priority of the detected event and the size of each of the pie charts may be related to a volume of data underlying that pie chart, and modified in real-time. Multiple simultaneous lines can also be displayed on a screen, with each simultaneous line having at least one pie chart, to expose patterns over time.

Additionally, the present invention is also directed to an intrusion management system for dynamically representing events detected on a monitored computer system, the detected events being detected by the intrusion management system in a communication with the monitored computer system. The intrusion management system includes a connection to the monitored computer system, a display and a processor for carrying out the above discussed methods. The present invention is also directed to a computer program product, embodied on a computer readable medium, configured to carry out the above discussed methods.

### BRIEF DESCRIPTION OF THE DRAWINGS

A preferred embodiment of the present invention will be set forth in detail with reference to the drawings, in which:

FIG. 1 is a block diagram showing a configuration of an intrusion management system between the Internet and an internal network according to the prior art;

FIG. 2 is a block diagram showing the same configuration as shown in FIG. 1, except from the standpoint of defending the internal network from an external attacker;

FIG. 3 is a screen capture of an alert browser, according to at least one embodiment of the present invention;

FIG. 4 is a screen capture of an alert browser, according to at least one embodiment of the present invention;

FIG. 5 is a screen capture of an alert browser, according to at least one embodiment of the present invention;

FIG. 6 is a screen capture of an alert browser, according to at least one embodiment of the present invention;

FIG. 7 is a screen capture of an alert browser, according to at least one embodiment of the present invention;

FIG. 8 is a screen capture of an alert browser, according to at least one embodiment of the present invention;

FIG. 9 is a screen capture of an alert browser, according to at least one embodiment of the present invention;

FIG. 10 is a screen capture of an alert browser, according to at least one embodiment of the present invention; and

FIG. 11 is a flow chart showing the operation of the intrusion management system, according to at least one embodiment of the present invention.

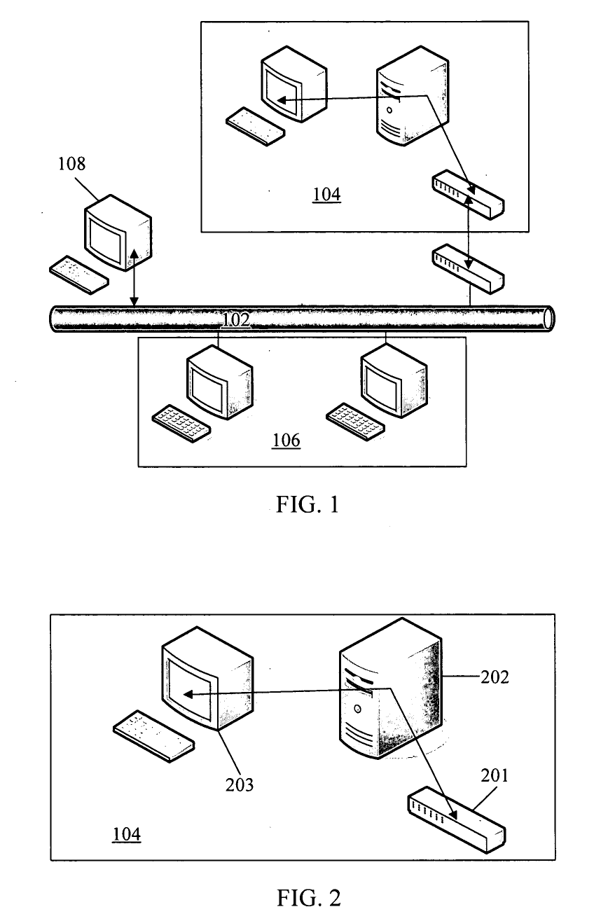

### DETAILED DESCRIPTION OF THE PREFERRED EMBODIMENT

A preferred embodiment of the present invention will be set forth in detail with reference to the drawings, in which like reference numerals refer to like elements or operational steps throughout.

The alert browser, according to the present invention, allows for the discovery and the highlighting of patterns in tabular data in real time as the data passed through it. That relieves the operator of the burden of having to watch the events as they come in and properly deduce patterns in the alerts. A discussion of a monitoring system according to the present invention is provided below.

The sensor monitors the network for suspicious activity and attacks. Those incidences are detected by the packages and backends installed on each sensor. Packages monitor a network for a specific category of exploit. Backends monitor the network for specific exploits. Packages and backends contain the actual instructions (N-Code) for filtering and processing network traffic. When the sensor detects a possible incident on the network, it generates an alert, which typically includes the name of the package and backend that identified the incident. Signatures are used to detect incidents and cause alerts to be generated. Each signature generates alerts with an alert name. Each alert has an Alert Name, Priority and Description to display in the alert browser window.

The system allows for monitoring of alerts from the desktop. In addition to monitoring alerts, the viewing of alerts can be tailored according to the network's needs. That tailoring includes viewing alerts by severity, through graphs and time lines, and through the process of selecting alert criteria. Components of the system can also be managed through the same interface. The system can also include a specific server that receives alerts from all servers in the system and allows for rules called correlators that cause certain actions to be taken when a number of alerts that contain identical values fall within specific fields.

The alert browser and alert history browser windows have a number of useful aspects. Automatic trend highlighting reveals patterns in the alert data. By adjusting the sort order, trend highlighting can show at a glance which IP address or ports are being heavily attacked or what sort of attack is occurring most. Alert grouping allows similar alerts to be grouped together based on configurable settings. Grouped alerts are collapsed into a single line item and individual groupings can be expanded or collapsed in place with a single mouse click. That replaces the rollup mechanism in other systems that is not configurable and does not allow in-place expansion of rolled-up alerts. The default displays for the alert browser and alert history browser windows are simplified to show only the most commonly used fields. Horizontal scrollbars facilitate viewing of more columns than can fit in a visible window.

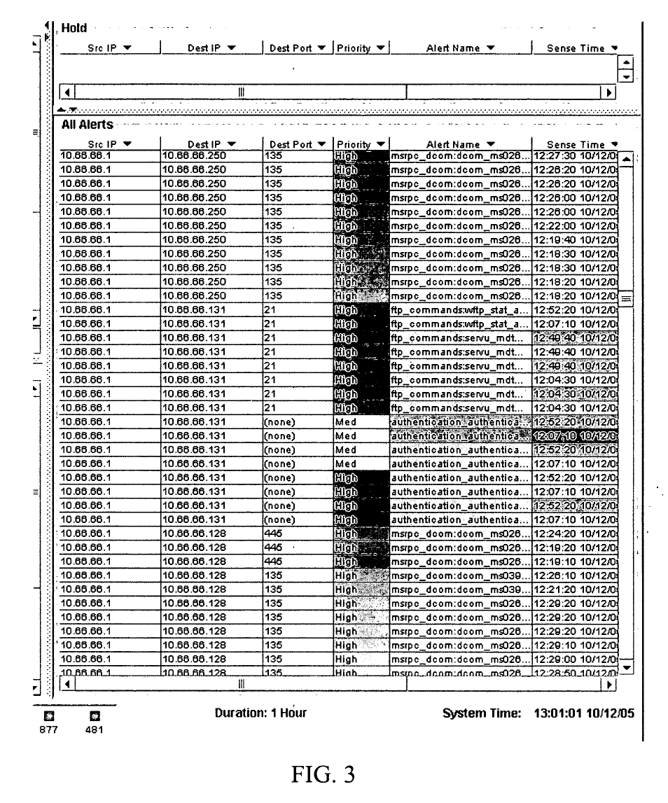

The alert browser can discover and highlight patterns in tabular data in real time as the data passed through it. One aspect that illustrates that property is that the browser sorts the tables in the order that the columns are in. All data is sorted on all columns starting from the left. In the example, illustrated in FIG. 3, the columns are ordered “Src Ip”, “Dest Ip”, “Dest Port”, “Priority”, “Alert Name”. Therefore, the column order determines the sort order.

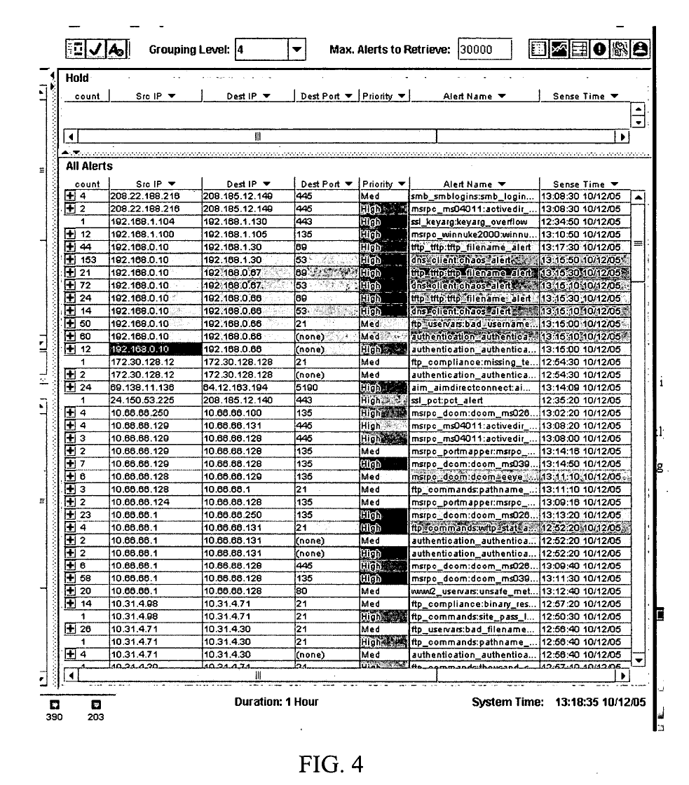

The view can also be collapsed to aggregate the data, as illustrated in FIG. 4. When collapsing the data, a column is chosen to be the one to be grouped on. That column, and all the columns to the left of it will have duplicates removed, and a count column will be put in to note how much data is hidden

It can be seen at a glance that the highlighted rows represent events with one source, and three destination addresses, where that is evident by the shading alone, before the text of the data is read, in this example and embodiment.

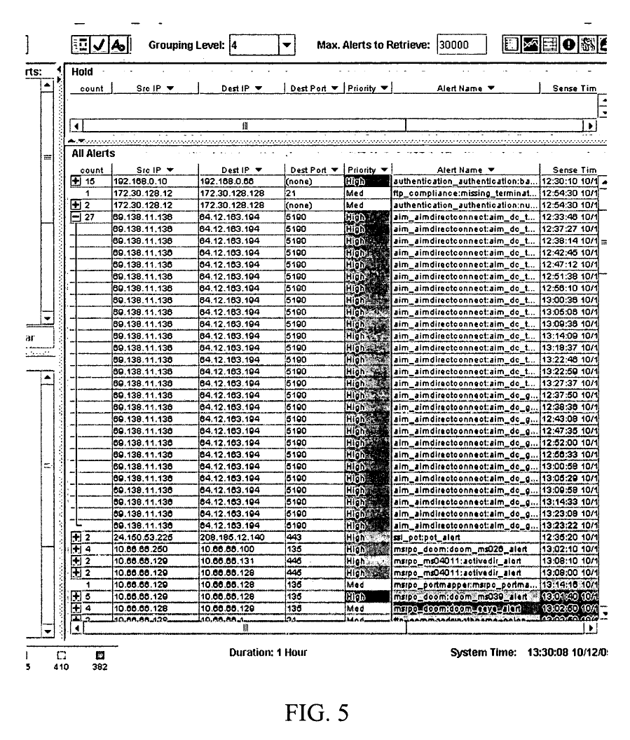

When a row is expanded, the full extent of the data can be seen, as illustrated in FIG. 5. It should be noted that even though the full contents of the alert name field for the expanded row cannot be read, it obviously has two distinct values because of the shading.

That feature makes it efficient to easy query the data by dragging the columns into a new ordering, and scrolling up and down through the data until the desired data is found. For example, instead of running a query by filtering it to find “high priority alerts on destination port 445”, the user just has to move the priority to the leftmost column, and destination port to the second column and scroll down to where “High” priority and destination port “445” are in the table. All such rows are now guaranteed to be contiguous in the table.

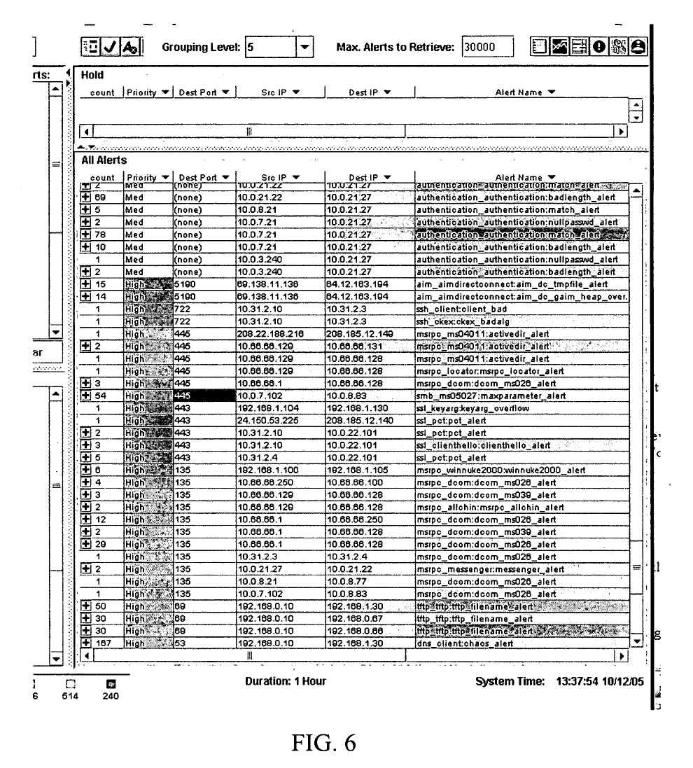

The High priority alerts on port 445 are grouped together, as illustrated in FIG. 6, with some of them being grouped together under the count because the grouping level control (at top of image) is set to 5 . . . meaning collapse rows where the first 5 columns are the same. That same set of features is useful for any kind of discrete tabular data which is not time oriented.

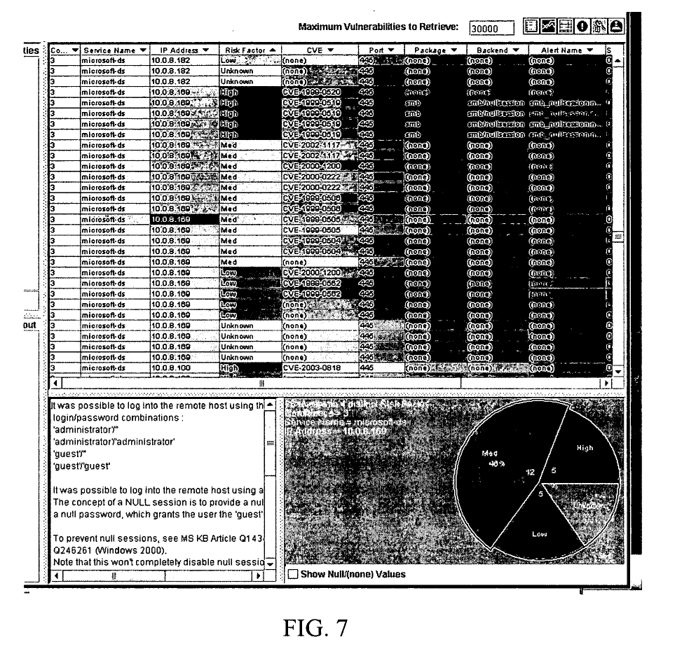

The data illustrated in the screen shot of FIG. 7 does not represent a time-series of events. It simply represents a large amount of discrete valued data (ip addresses, ports, names, etc). Since this user interface is not faced with new data instantly coming in and scrolling the windows around, it simply highlights adjacent rows that are under the same portion of the tree, and displays the distribution of those rows in a pie chart. The column selected is the column on which the grouping is performed. The column to the left of the one highlighted is the parent node in the tree, and the column to the right of the one selected is the child nodes of the tree. There are four distinct values that are children of 10.0.8.159, and their distribution by volume is shown as a pie chart, in FIG. 7.

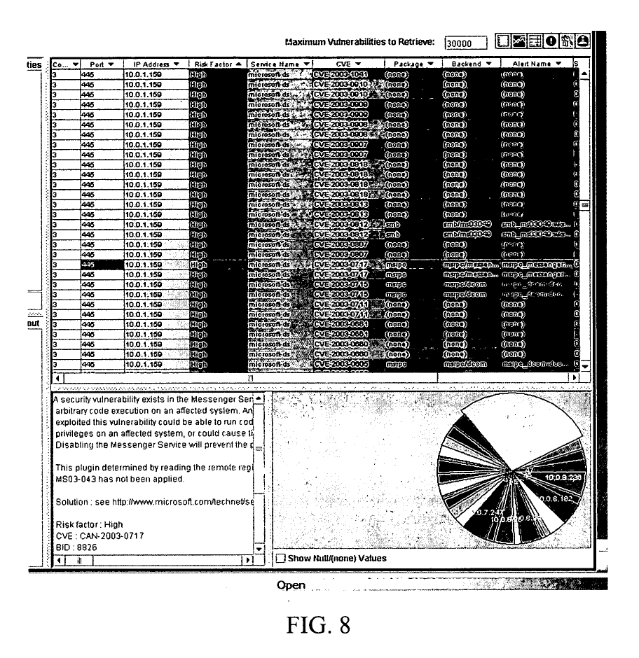

Again, this allows for querying of the data without filtering anything out. If the analyst wants to see which ip addresses have data on port 445, it can be seen that one host obviously stands out. Similarly, as illustrated in FIG. 8, if the user wants to find out which problems are responsible for that happening, then drilling down into the data is just a matter of moving the cursor to the right.

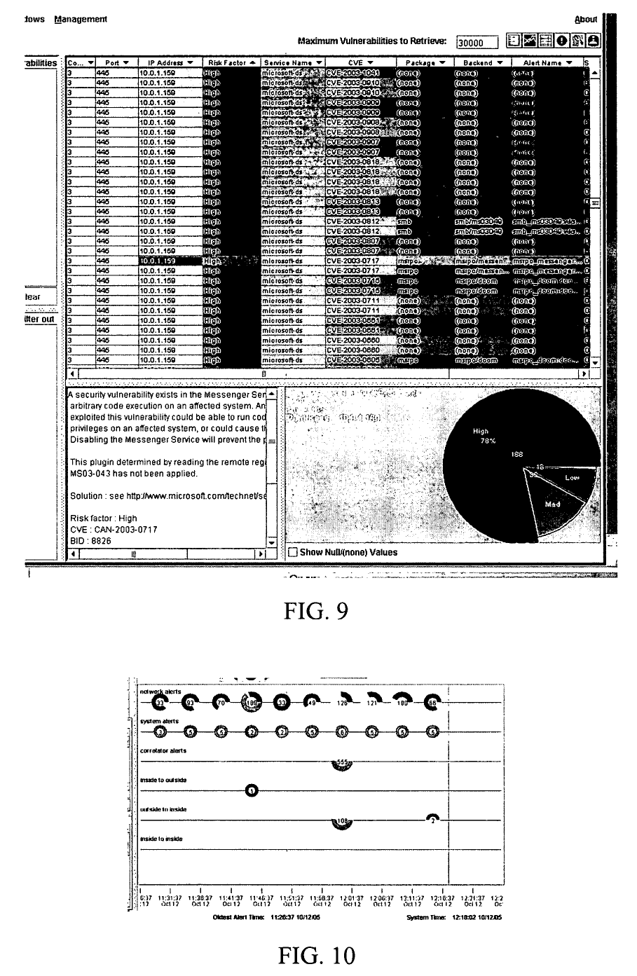

As illustrated in FIG. 9, the group sorted consolidation control has these features (whether by consolidating by collapsing the nodes, or by highlighting nodes which fall under the same part of the tree). It gives the tabular data a tree-like structure in which the precedence of the nodes in the tree can be instantly re-arranged. It highlights trends that can normally only be found by filtering out data by criteria. With event based data, it allows the user to look at all the data within a time frame without filtering anything out, and analyze it in real-time. The sorting gives the analyst time to read alerts before they fall out of the window. If alerts are coming in at a very high rate, then the duration can be set shorter and the grouping level can be set to group on fewer columns to keep the data comprehensible. Thus, this user interface is designed to allow an analyst to comprehend millions of alerts coming in per day.

Pseudo-Code Implementation

In order for the browser to properly display and update in real time, it has to be very fast because events are coming in very quickly (rated capacity is 10 per second). The implementation is not literally the same as the code discussed below, because it is believed that the pseudo-code is a more comprehensible equivalent than the actual code and doesn't get caught up in application specific bookkeeping.

Every time a new group of events come in, they must be sorted before anything can be displayed to the user. In addition, the data re-sorts and re-colors as the column orders get re-arranged.

When two rows are compared for the purposes of sorting, the comparison goes across every column until there is a mismatch, like:

```
compare(row0,row1)
{
    foreach c in (0..(ColumnCount−1))
    {
        if row0[c] < > row1[c]
    {
        -- comparison will return −1 if less, +1
if greater, 0 if same
        return compare(row1,row0)
    }
    }
    return 0
}
```

Once this data is sorted, it is prepared for the second pass of the algorithm. The data gets markings on it so that it can be efficiently colored. A number corresponding to each row is stored so that it can be used to remember where the first change (from left to right) occurs between rows. A second number corresponding to the final color hints to the shader is also stored.

The sorted data is iterated from top to bottom. As that is done, the first row (row 0) is assumed to have no bits set, then begin iterating:

```
diffColumns[0] = 0
diffBits[0] = 0
foreach r in (1..(RowCount−1))
{
    -- at which column do these rows differ (going
from left to right)?
    diffColumns[r] = firstColumnDiff(row[r−
1],row[r])
    -- toggle the bit corresponding to the column
    that changed...
    -- in pseudo C/Java notation - this makes the
    bits ALTERNATE
    diffBits[r] = diffBits[r−1] \hat{ }
(1<<diffColumns[r])
}
```

At the end of that iteration, there are now enough hints for the shader to pick the color, and for the consolidation to determine the rows location in the tree.

When trying to determine the darkness of a column, a simple function can be defined for that now:

```
    -- add up the diffBits - they determine coloring
    darkness(row,column)
    {
        darkness=0
        -- sum the bits turned on that are less than
for this column
        foreach c (0..Column)
        {
            -- pseudo C/Java notation again
            -- if the bits for this column are turned
on for this row
            if ((1<<c) & diffBits[r]) < > 0
            {
                darkness = darkness + 1
            }
        }
        return darkness
    }
```

The actual function to determine the coloring is more complex because of application specific considerations, but what is important is that the data structures have the minimum required information to come up with a sensible coloring for the table cell.

Variable Radius Event Timelines

In a typical Intrusion Detection System, there is always an issue of how to deal with very large volumes of event data coming in. A typical line graph, or a set of line graphs don't really help because a large number of graphs need to be observed simultaneously. Animation is used to shift the timeline to the left to keep the current time “now” marked with a line through all the timelines.

The variable radius event timelines aggregate a stream of events that each at least have a timestamp and a priority level (typically they are high, medium, and low). A stream of events coming in might resemble something like:

(11:50, High), (11:51,Med), (11:53,Med),(12:02,Med),(12:03,Low),(13:03,High). . . .

Each event has a time and a priority here. The timeline is broken up into chunks (per hour, for instance). Events get collected into each time chunk. Each chunk will eventually get drawn as a pie chart. As each event gets put into a chunk, the size of that chunk gets incremented while the pie chart is adjusted to show the new priority distribution. So, the chunks are initialized with data structures that are like:
(11, High=0, Med=0, Low=0)
(12, High=0, Med=0, Low=0)
(13, High=0, Med=0, Low=0)

If the stream of events is passed
(11:50, High), (11:51, Med), (11:53, Med),(12:02, Med),(12:03, Low),(13:03, High). . . .
   then the counters will look like
(11, High=1, Med=2, Low=0)
(12, High=0, Med=1, Low=1)
(13, High=1, Med=0, Low=0)

For each chunk, the percentage of the pies that get drawn will be
High % =High/(High+Med+Low)
Medium % =Low/(High+Med+Low)
Low % =Low/(High+Med+Low)

The radius of each pie is logarithmically related to the total volume of data represented. When drawn the radius will be:
minimumRadius+constantScalingFactor*Log 10(High+Med+Low),
which can be computed in various ways (such as starting with a maximum radius and subtracting a constant amount from the starting radius for each digit in the decimal number (High+Med+Low). Therefore, the “size” refers to the overall circumference of the pie chart and is scaled according to the volume of data that is represents.

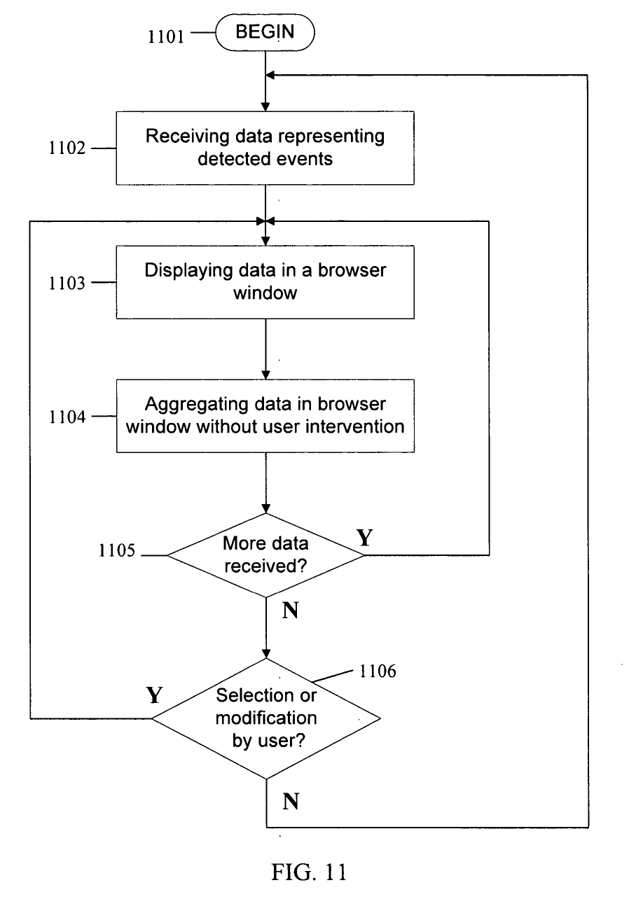

The general method of the present invention is also illustrated in FIG. 11 as a flowchart. After the begin step 1101, data is received representing detected events, in step 1102. Thereafter, in step 1103, the data is displayed in a browser window and then automatically aggregated, to highlight patterns in the data, in step 1104. Next, in step 1105, it is determined whether further data has been received, and whether further display and/or aggregation is needed. If not, then user interaction is detected, such as whether the display or additional characteristics should be altered, in step 1106.

The system of the present invention allows for the discovery and the highlighting of patterns in tabular data in real time as the data passed through it. That relieves the operator of the burden of having to watch the events as they come in and properly deduce patterns in the alerts.

While a preferred embodiment has been set forth in detail above, those skilled in the art will readily appreciate that other embodiments can be realized within the scope of the invention. For example, numerical values are illustrative rather than limiting, as is the order in which steps are carried out. Moreover, one or two of the above-noted scalars can be used; similarly, any or all of the above-noted scalars can be used in combination with other scalars. Therefore, the present invention should be construed as limited only by the appended claims.

What is claimed is:

1. A method for dynamically representing events detected by an intrusion management system in communication with a monitored computer system, the method comprising the steps of:
receiving data representing detected events in real time;
displaying the data in a browser window of the intrusion management system;
aggregating, automatically, data in the browser window to highlight patterns therein, without intervention of a user of the intrusion management system; and
updating the aggregated data based on newly received data and selections by the user of the intrusion management system.

2. The method, as recited in claim 1, wherein the steps of displaying and aggregating comprise displaying large amounts of tabular data and sorting from left to right on all the tabular data such that the sorting clusters the tabular data together into a tree structure with a hierarchy.

3. The method, as recited in claim 2, wherein the hierarchy is modified in real-time to provide patterns in the data.

4. The method, as recited in claim 2, further comprising coloring entries in the tabular data to provide at a glance illustration of the hierarchy of the tabular data.

5. The method, as recited in claim 4, wherein the coloring of the entries of the tabular data is modified in real-time to provide patterns in the data.

6. The method, as recited in claim 4, further comprising grouping the entries into clusters based on the coloring of the entries of the tabular data.

7. The method, as recited in claim 1, wherein the steps of displaying and aggregating comprise displaying large amounts of tabular data and displaying pie chart distributions of the tabular data that is being aggregated.

8. The method, as recited in claim 1, wherein the step of displaying comprises displaying time based occurrences with a pie chart for each time interval to show a distribution of a primary attribute for the detected events.

9. The method, as recited in claim 8, wherein the primary attribute comprises a priority of the detected event.

10. The method, as recited in claim 8, wherein a size of each of the pie charts is related to a volume of data underlying that pie chart.

11. The method, as recited in claim 8, wherein the size of each of the pie charts is modified in real-time.

12. The method, as recited in claim 8, wherein multiple simultaneous lines are displayed on a screen, with each simultaneous line having at least one pie chart, to expose patterns over time.

13. An intrusion management system for dynamically representing events detected on a monitored computer system, the detected events being detected by the intrusion management system in communication with the monitored computer system, the intrusion management system comprising:
a connection to the monitored computer system; and
a processor and a display for:
receiving data representing detected events in real time;
displaying the data in a browser window of the intrusion management system;
aggregating, automatically, data in the browser window to highlight patterns therein, without intervention of a user of the intrusion management system; and
updating the aggregated data based on newly received data and selections by the user of the intrusion management system.

14. The intrusion management system, as recited in claim 13, wherein the processor performs the steps of displaying and aggregating by displaying large amounts of tabular data and sorting from left to right on all the tabular data such that the sorting clusters the tabular data together into a tree structure with a hierarchy.

15. The intrusion management system, as recited in claim 14, wherein the hierarchy is modified in real-time to provide patterns in the data.

16. The intrusion management system, as recited in claim 14, wherein the processor further performs by coloring entries in the tabular data to provide at a glance illustration of the hierarchy of the tabular data.

17. The intrusion management system, as recited in claim 16, wherein the coloring of the entries of the tabular data is modified in real-time to provide patterns in the data.

18. The intrusion management system, as recited in claim 16, wherein the processor further performs by grouping the entries into clusters based on the coloring of the entries of the tabular data.

19. The intrusion management system, as recited in claim 13, wherein the processor performs the steps of displaying and aggregating by displaying large amounts of tabular data and displaying pie chart distributions of the tabular data that is being aggregated.

20. The intrusion management system, as recited in claim 13, wherein the processor performs the step of displaying by displaying time based occurrences with a pie chart for each time interval to show a distribution of a primary attribute for the detected events.

21. The intrusion management system, as recited in claim 20, wherein the primary attribute comprises a priority of the detected event.

22. The intrusion management system, as recited in claim 20, wherein a size of each of the pie charts is related to a volume of data underlying that pie chart.

23. The intrusion management system, as recited in claim 20, wherein the size of each of the pie charts is modified in real-time.

24. The intrusion management system, as recited in claim 20, wherein the processor displays multiple simultaneous lines on a screen, with each simultaneous line having at least one pie chart, to expose patterns over time.

25. A computer program product, having a computer program embodied in a computer readable medium, adapted to perform a method of dynamically representing events detected on a monitored computer system, the detected events being detected by an intrusion management system in communication with the monitored computer system, comprising the steps of:
receiving data representing detected events in real time;
displaying the data in a browser window of the intrusion management system;
aggregating, automatically, data in the browser window to highlight patterns therein, without intervention of a user of the intrusion management system; and
updating the aggregated data based on newly received data and selections by the user of the intrusion management system.

26. The computer program product, as recited in claim 25, wherein the steps of displaying and aggregating comprise displaying large amounts of tabular data and sorting from left to right on all the tabular data such that the sorting clusters the tabular data together into a tree structure with a hierarchy.

27. The computer program product, as recited in claim 26, wherein the hierarchy is modified in real-time to provide patterns in the data.

28. The computer program product, as recited in claim 26, further comprising coloring entries in the tabular data to provide at a glance illustration of the hierarchy of the tabular data.

29. The computer program product, as recited in claim 28, wherein the coloring of the entries of the tabular data is modified in real-time to provide patterns in the data.

30. The computer program product, as recited in claim 28, further comprising grouping the entries into clusters based on the coloring of the entries of the tabular data.

31. The computer program product, as recited in claim 25, wherein the steps of displaying and aggregating comprise displaying large amounts of tabular data and displaying pie chart distributions of the tabular data that is being aggregated.

32. The computer program product, as recited in claim 25, wherein the step of displaying comprises displaying time based occurrences with a pie chart for each time interval to show a distribution of a primary attribute for the detected events.

33. The computer program product, as recited in claim 32, wherein the primary attribute comprises a priority of the detected event.

34. The computer program product, as recited in claim 32, wherein a size of each of the pie charts is related to a volume of data underlying that pie chart.

35. The computer program product, as recited in claim 32, wherein the size of each of the pie charts is modified in real-time.

36. The computer program product, as recited in claim 32, wherein multiple simultaneous lines are displayed on a screen, with each simultaneous line having at least one pie chart, to expose patterns over time.
